(19) United States
(12) Patent Application Publication
(10) Pub. No.: US 2026/0201263 A1
(43) Pub. Date: Jul. 16, 2026

(54) FUEL BORNE CATALYST COMPOSITION FOR OXIDATIVE SOOT REMOVAL

(71) Applicant: UMICORE SPECIALTY MATERIALS BRUGGE, Brugge (BE)

(72) Inventors: Carl VERCAEMST, Brugge (BE); Garrett MINNE, Brugge (BE); William Hendrik FAVEERE, Brugge (BE); Maxime VERMETTEN, Brugge (BE)

(21) Appl. No.: 18/879,843

(22) PCT Filed: Jun. 29, 2023
(86) PCT No.: PCT/EP2023/067830

§ 371 Date: Dec. 30, 2024

(30) Foreign Application Priority Data
Jun. 30, 2022 (EP) 22182156.4

(51) Int. Cl. C10L 1/188; B01D 46/84; B01J 31/02; C10L 10/06

(52) U.S. Cl. CPC C10L 1/188; B01D 46/84; B01J 31/0211; C10L 10/06; B01D 2258/012; C10L 2270/026

(57) ABSTRACT

The present invention provides fuel borne catalyst compositions for oxidative soot removal comprising a Ce (III) long-chain carboxylate in an organic solvent. Preferred embodiments provide a cerium composition for use as a soot reduction catalyst system, comprising: Ce (III) neodecanoate; Ce (III) carboxylate, wherein said carboxylate has a general formula RCOO-, wherein R is H or a Cl to C4 alkyl; neodecanoic acid; and an organic solvent.

WO

### TECHNICAL FIELD

The present invention relates to fuel borne catalyst composition for oxidative soot removal. The invention aims to reduce the emission of particulates from diesel engines and improve the function of the diesel particulate filter (DPF).

### INTRODUCTION

The diesel engine is an internal combustion engine in which ignition of the fuel is caused by the elevated temperature of the air in the cylinder due to mechanical com-pression. Although diesel engines typically show a low exhaust level of carbon monoxide and hydrocarbons, exhaust gases contain specific levels of particulate matter or soot. A diesel particulate filter (DPF) allows to reduce the amount of soot from the exhaust gas of a diesel engine. Particulates (soot) are collected on the filter, and the filter is regenerated actively or passively to burn soot. Motivated by energy considerations, durability and system design, an ideal particulate removal unit should minimize the regeneration temperature of the soot filter. To this end, soot reduction catalysts, also referred to as fuel borne catalysts (FBC's), have been developed.

US 2009/004078 discloses a catalysed diesel soot filter and process. The diesel soot filter incorporates a porous filter element coated with a catalytic agent so that diesel soot from diesel exhaust gas is deposited into contact with the catalytic agent when Diesel exhaust gas is passed through the porous filter element and so that the ignition temperature or oxidation temperature of the deposited diesel soot is reduced. The catalytic agent is a mixture of alkali metal and cerium oxides.

US 2007/283681 discloses a method for reducing emissions of particulates from diesel engines, which comprises: operating a diesel engine with a fuel containing a fuel borne catalyst comprising a fuel soluble or dispersible cerium composition and a fuel soluble or dispersible platinum group metal composition. The process employs a fuel-soluble, multi-metal catalyst, i.e., a fuel borne catalyst (FBC) comprising a fuel-soluble or dispersible platinum group metal composition and a fuel-soluble or dispersible cerium composition. The cerium composition is preferably employed at concentrations effective to provide from 0.5 to 20 ppm cerium. The platinum group metal composition is preferably employed at concentrations effective to provide from 0.0005 to 2 ppm platinum.

### SUMMARY

The current invention provides a solution for at least one of the above mentioned problems by providing a fuel borne catalyst composition for oxidative soot removal, as described in claim 1. Results showed that use of said cerium composition allows for an efficient soot removal and regeneration of the diesel particulate filter.

The present invention further provides a process for preparing the compositions according to the general inventive concept, a method for operating a diesel engine wherein the compositions according to the general inventive concept are employed and the use of the compositions according to the general inventive concept for the purposes of soot removal in a diesel particulate filter.

### DESCRIPTION OF THE FIGURES

By means of further guidance, figures are included to better appreciate the teaching of the present invention. Said figures are intended to assist the description of the invention and are nowhere intended as a limitation of the presently disclosed invention.

The figures and symbols contained therein have the meaning as commonly understood by one of ordinary skill in the art to which this invention belongs.

FIG. 1 shows the efficiency of soot removal, expressed as a percentage of the total amount of soot, as a function of the oxidative temperature in °C. for cerium compositions according to the invention, cerium compositions according to the prior art, and compositions without soot removal catalyst, respectively.

FIG. 2 shows the efficiency of soot removal after 10 minutes at 575° C. for cerium compositions according to the invention, cerium compositions according to the prior art, and compositions without soot removal catalyst, respectively.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings: “A”, “an”, and “the” as used herein refers to both singular and plural referents unless the context clearly dictates otherwise. By way of example, “a compartment” refers to one or more than one compartment. “About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints. All percentages are to be understood as percentage by weight, abbreviated as “wt. %” or as volume per cent, abbreviated as “vol. %”, unless otherwise defined or unless a different meaning is obvious to the person skilled in the art from its use and in the context wherein it is used.

The term “fuel” is thus intended to include all of those fuels effective for operating diesel engines. The fuel can contain detergent (e.g., 50-300 ppm), lubricity additive (e.g., 25 to about 500 ppm) and other additives, as desired. Among the fuels suitable for use in the invention are those which typically comprise a fossil fuel, such as any of the typical petroleum-derived fuels including distillate fuels. A fuel can be one or a blend of fuels selected from the group consisting of: distillate fuels, including diesel fuel, e.g., No. 2 Diesel fuel, No. 1 Diesel fuel, jet fuel, e.g., Jet A, or the like which is similar in boiling point and viscosity to No. 1 Diesel fuel, ultra-low sulfur diesel fuel (ULSD); liquid fuels comprising hydrocarbons derived from gaseous or solid fuels; and biologically-derived fuels, such as those comprising a “mono-alkyl ester-based oxygenated fuel”, i.e., fatty acid esters, preferably methyl or ethyl esters of fatty acids derived from triglycerides, e.g., soybean oil, Canola oil and/or tallow, or “Gas-to-Liquids” fuels derived from biomass, natural gas, coal or petroleum sources. The term “hydrocarbon fuel” is meant to include all of those fuels prepared from “distillate fuels” or “petroleum”. Gasoline, jet fuel, diesel fuel, and various other distillate fuels are included. The term “distillate fuel” means all of those products prepared by the distillation of petroleum or petroleum fractions and residues. The term “petroleum” is meant in its usual sense to include all of those materials regardless of source normally included within the meaning of the term, including hydrocarbon materials, regardless of viscosity, that are recovered from fossil fuels.

Jet A and Diesel No. 1 are deemed equivalent for applications of the invention, but are covered by different American Society For Testing and Materials (ASTM) specifications. The diesel fuels are covered by ASTM D 975, “Standard Specification for Diesel Fuel Oils”. Jet A has the designation of ASTM D 1655, “Standard Specification for Aviation Turbine Fuels”. The term ultra-low sulfur diesel fuel (ULSD) means No. 1 or No. 2 diesel fuels with a sulfur level no higher than 0.0015 percent by weight (15 ppm) and some jurisdictions require a low aromatic hydrocarbon content e.g., less than ten percent by volume.

The term “diesel fuel” means “distillate fuels” including diesel fuels meeting the ASTM definition for diesel fuels or others even though they are not wholly comprised of distillates and can comprise alcohols, ethers, organo-nitro compounds and the like (e.g., methanol, ethanol, diethyl ether, methyl ethyl ether, nitromethane). Also within the scope of this invention, are emulsions and liquid fuels derived from vegetable or mineral sources such as corn, alfalfa, shale, and coal. These fuels may also contain other additives known to those skilled in the art, including dyes, cetane im-provers, anti-oxidants such as 2,6-di-tertiary-butyl-4-methylphenol, corrosion inhibitors, rust inhibitors such as alkylated succinic acids and anhydrides, bacteriostatic agents, gum inhibitors, metal deactivators, upper cylinder lubricants, anti-icing agents and the like.

The method for operating a diesel engine of the invention employs a cerium catalyst, i.e., a fuel borne catalyst (FBC), preferably comprising a fuel-soluble or a fuel-dispersible cerium composition. The cerium composition is preferably employed at concentrations effective to provide from 0.5 to 150 ppm cerium, more preferably from 1 to 100 ppm cerium, and even from 5 to 50 ppm cerium. Said method may further employ a platinum group metal composition at concentrations effective to provide from 0.0005 to 2 ppm platinum. In some embodiments, the treatment regimen can call for the utilizing of higher catalyst concentrations initially or at defined intervals or as needed, but not for the whole treatment. An advantage of low levels of catalyst is the reduction in ultra-fine particles resulting from carbonaceous soot and metal oxide emissions.

Cerium compositions according to the general inventive aspect of the invention may comprise one or more chemical enhancers such as those described in, but not limited to, US 2007/283681.

According to the general inventive aspect of the invention, the present invention provides a cerium composition comprising a long-chain Ce (III) carboxylate in an organic solvent. Preferred composition comprise a content of Ce (III) of 1 to 20 wt. %, relative to the total weight of the composition, preferably 2 to 18 wt. %, more preferably 3 to 16 wt. %, even more preferably 5 to 15 wt. %, and most preferably 6 wt. %, 8 wt. %, 10 wt. %, 12 wt. %, 14 wt. %, or any value there in between.

In a preferred embodiment, the invention according to the general inventive aspect provides a cerium composition comprising:
A. a long-chain Ce (III) carboxylate;
B. a long-chain carboxylic acid; and
C. an organic solvent, wherein said long-chain carboxylate is a conjugate base of said long-chain carboxylic acid. In a preferred embodiment, said cerium composition also comprises a short-chain Ce (III) carboxylate.

In a preferred embodiment, the present invention provides a cerium composition according to the general inventive aspect of the invention, wherein said long-chain Ce (III) carboxylate is a Ce (III) carboxylate with carboxylate groups having 6 to 24 carbon atoms, and wherein said short-chain cerium (III) carboxylate is a Ce (III) carboxylate with carboxylate groups having 1 to 5 carbon atoms. Preferably, said long-chain cerium (III) carboxylate is a Ce (III) carboxylate with carboxylate groups having 9 to 20 carbon atoms, and more preferably 10 to 16 carbon atoms; and said short-chain cerium (III) carboxylate is a Ce (III) carboxylate with carboxylate groups having 2 to 4 carbon atoms. In some embodiments, said long-chain cerium (III) carboxylate may be comprised as a mixture of two or more long-chain cerium (III) carboxylates. In some embodiments, said long-chain carboxylate is selected of the group comprising saturated carboxylates such as alkylcarboxylate, cycloalkylcarbox-ylate, and unsaturated carboxylates. Said long-chain carboxylate groups may include aliphatic, alicyclic, aryl and alkylaryl groups. Preferably, said long-chain cerium (III) carboxylate is comprised of an unsaturated carboxylate. Selected long-chain cerium (III) carboxylate compounds are: cerium (III) naphthenate, cerium (III) octoate, cerium (III) 2-ethylhexanoate, cerium (III) isononate, cerium (III) 3,5,5-trimethylhex-anoate, cerium (III) versatate, cerium (III) oleate, cerium (III) ricinoleate, and other soaps such as stearate and neodecanoate. Selected short-chain cerium (III) carboxylate compounds are: cerium (III) formate, cerium (III) propionate, and cerium (III) acetylacetonate. Alternatively, cerium (III) acetate can be used. In some embodiments, said short-chain cerium (III) carboxylate may be comprised as a mixture of two or more short-chain cerium (III) carboxylates. Said organic solvent may be a blend of two or more organic solvents. Preferably, said organic solvent is a hydrocarbon solvent comprising C10-C13 alkanes.

In a preferred embodiment, the present invention provides a cerium composition according to the general inventive aspect of the invention, wherein said long-chain Ce (III) carboxylate is Ce (III) neodecanoate; wherein said short-chain Ce (III) carboxylate is a Ce (III) carboxylate wherein said carboxylate has a general formula RCOO, wherein R is H or a C1 to C4 alkyl; and wherein said long-chain carboxylic acid is neodecanoic acid.

In a preferred embodiment, the present invention provides a cerium composition according to the general inventive aspect of the invention, wherein said long-chain Ce (III) carboxylate is comprised in an amount of 20 to 55 wt. %, relative to the total weight of the composition, preferably in an amount of 30 to 50 wt. %, and more preferably in an amount of 40 to 45 wt. %. Most preferably, said long-chain Ce (III) carboxylate is comprised in an amount of about 41 wt. %, 43 wt. % or 45 wt. %, or any amount there in between.

In a preferred embodiment, the present invention provides a cerium composition according to the general inventive aspect of the invention, wherein said short-chain Ce (III) carboxylate is comprised in an amount of 0.1 to 10 wt. %, relative to the total weight of the composition, preferably in an amount of 0.5 to 5 wt. %, and more preferably in an amount of 1 to 3 wt. %. Most preferably, said short-chain Ce (III) carboxylate is comprised in an amount of about 1 wt. %, 2 wt. % or 3 wt. %, or any amount there in between.

In a preferred embodiment, the present invention provides a cerium composition according to the general inventive aspect of the invention, wherein said long-chain carboxylic acid is comprised in an amount of 1 to 30 wt. %, relative to the total weight of the composition, preferably in an amount of 2 to 30 wt. %, and more preferably in an amount of 2 to 20 wt. %. Most preferably, said long-chain carboxylic acid is comprised in an amount of about 2 wt. %, 4 wt. %, 6 wt. %, 8 wt. %, or 10 wt. %, or any amount there in between.

In a preferred embodiment, the present invention provides a cerium composition according to the general inventive aspect of the invention, wherein said composition further comprises an organic solvent. Preferably, said organic solvent is comprised in an amount of 5 to 78.9 wt. %, preferably in an amount of 15 to 67.5 wt. %, and more preferably in an amount of 22 to 57 wt. %. Most preferably, said organic solvent is comprised in an amount of about 25 wt. %, 30 wt. %, 35 wt. %, 40 wt. %, or 45 wt. %, or any amount there in between.

In a first aspect, the present invention provides a cerium composition for use as a soot reduction catalyst system, comprising:
i. Ce (III) neodecanoate;
ii. neodecanoic acid; and
iii. an organic solvent.

In a preferred embodiment, said cerium composition also comprises a short-chain Ce (III) carboxylate, wherein said carboxylate has a general formula RCOO⁻, wherein R is H or a C1 to C4 alkyl. The inventors have found that the cerium composition according to the first aspect of the invention can advantageously be used as a soot reduction catalyst system in a diesel engine. Results showed that use of said cerium composition allows for an efficient soot removal and regeneration of the diesel particulate filter. Specifically, it was found that the cerium composition according to the invention allows for (i) a lower dosage of the cerium composition in the fuel, compared to state of the art compositions, while generating a similar soot activity; (ii) increased efficiency of catalytic oxidation in terms of higher soot conversion, thus superior performance; (iii) regeneration of the diesel particulate filter at a relatively lower temperature, i.e., at 450° C. instead of 600° C. in absence of fuel borne catalyst; and (iv) less ash formation.

Moreover, secondary advantages are achieved such as a reduced time to achieve the regeneration temperature and a reduction in regeneration time to below 7 minutes or even below 4 minutes can be achieved, depending on the dosage of the cerium composition. Instant soot removal can be achieved and high soot removal efficiency is possible. Complete combustion of the accumulated soot particles allows for an extended life time of the diesel particulate filter. Active regeneration can be achieved within less than 4 minutes at a relatively low temperature of 450° C. A high catalytic oxidation can be achieved by a good dispersion of cerium in soot particulate.

The organic solvent further allows for a good compatibility of the cerium composition with fuel. The cerium composition forms a stable, homogeneous mixture in fuel.

In a preferred embodiment, the present invention provides a cerium composition according to the first aspect of the invention, comprising:
i. Ce (III) neodecanoate, in an amount of 20 to 55 wt. %, relative to the total weight of the composition;
ii. neodecanoic acid, in an amount of 1 to 30 wt. %, relative to the total weight of said composition; and
iii. an organic solvent, in an amount of 15 to 79 wt. %, relative to the total weight of said composition.

Preferably, said composition comprises:
i. Ce (III) neodecanoate, in an amount of 20 to 55 wt. %, relative to the total weight of the composition;
ii. Ce (III) carboxylate, wherein said carboxylate has a general formula RCOO⁻, wherein R is H or a C 1 to C 4 alkyl, in an amount of 0.1 to 10 wt. %, relative to the total weight of said composition;
iii. neodecanoic acid, in an amount of 1 to 30 wt. %, relative to the total weight of said composition; and
iv. an organic solvent, in an amount of 5 to 78.9 wt. %, relative to the total weight of said composition.

More preferably, the present invention provides a cerium composition according to the first aspect of the invention, comprising:
i. Ce (III) neodecanoate, in an amount of 30 to 50 wt. %, relative to the total weight of the composition;
ii. neodecanoic acid, in an amount of 2 to 30 wt. %, relative to the total weight of said composition; and
iii. an organic solvent, in an amount of 20 to 68 wt. %, relative to the total weight of said composition.

Preferably, said cerium composition comprises:
i. Ce (III) neodecanoate, in an amount of 30 to 50 wt. %, relative to the total weight of the composition;

ii. preferably, Ce (III) carboxylate, wherein said carboxylate has a general formula RCOO⁻, wherein R is H or a C1 to C4 alkyl, in an amount of 0.5 to 5 wt. %, relative to the total weight of said composition;
iii. neodecanoic acid, in an amount of 2 to 30 wt. %, relative to the total weight of said composition; and
iv. an organic solvent, in an amount of 15 to 67.5 wt. %, relative to the total weight of said composition.

Even more preferably, the present invention provides a cerium composition according to the first aspect of the invention, comprising:
i. Ce (III) neodecanoate, in an amount of 40 to 45 wt. %, relative to the total weight of the composition;
ii. neodecanoic acid, in an amount of 2 to 30 wt. %, relative to the total weight of said composition; and
iii. an organic solvent, in an amount of 25 to 58 wt. %, relative to the total weight of said composition.

Preferably, said cerium composition comprises:
i. Ce (III) neodecanoate, in an amount of 40 to 45 wt. %, relative to the total weight of the composition;
ii. Ce (III) carboxylate, wherein said carboxylate has a general formula RCOO⁻, wherein R is H or a C1 to C4 alkyl, in an amount of 1 to 3 wt. %, relative to the total weight of said composition;
iii. neodecanoic acid, in an amount of 2 to 30 wt. %, relative to the total weight of said composition; and
iv. an organic solvent, in an amount of 22 to 57 wt. %, relative to the total weight of said composition.

In a preferred embodiment, the present invention provides a cerium composition according to the first aspect of the invention, wherein the molar ratio of neodecanoic acid to Ce (III) neodecanoate is between 0.1 and 5.0. Preferably, said molar ratio is between 0.5 and 3.0, and more preferably between 1 and 3, said ratio is about 1.6, 1.8, 2.0, 2.2, 2.4, 2.6 or 2.8, or any value there in between. Excess amounts of neodecanoic acid may be neutralized or partially neutralized.

In a preferred embodiment, the present invention provides a cerium composition according to the first aspect of the invention, wherein said carboxylate is selected from the group comprising: formate, acetate and propionate. The selected carboxylates showed an improved reactivity with a Ce (III) precursor such as Ce (III) carbonate.

In a preferred embodiment, the present invention provides a cerium composition according to the first aspect of the invention, wherein said organic solvent is a hydrocarbon solvent comprising C10-C13 alkanes.

In a preferred embodiment, the present invention provides a cerium composition according to the first aspect of the invention, wherein said organic solvent is a C6-C10 aliphatic monoalcohol ether.

In a preferred embodiment, the present invention provides a cerium composition according to the first aspect of the invention, wherein said organic solvent is a mixture of a hydrocarbon solvent comprising C10-C13 alkanes and a C6-C10 aliphatic monoalcohol ether.

Preferably, the present invention provides a cerium composition according to the first aspect of the invention, wherein said organic solvent is a hydrocarbon solvent comprising C9-C10 alkanes. Preferably, said hydrocarbon solvent is comprised in an amount of at least 30 wt. %, relative to the total weight of said organic solvent, more preferably in an amount of at least 40 wt. %, and most preferably in an amount of about 50 wt. %. Said hydrocarbon solvent may comprise n-alkanes, isoalkanes, and cycloalkanes. Said hydrocarbon solvent preferably has CAS No.: 64742-48-9 and preferably comprises less than 2% aromatics.

Preferably, the present invention provides a cerium composition according to the first aspect of the invention, wherein said organic solvent is a hydrocarbon solvent comprising C10-C13 alkanes. Preferably, said hydrocarbon solvent is comprised in an amount of at least 30 wt. %, relative to the total weight of said organic solvent, more preferably in an amount of at least 40 wt. %, and most preferably in an amount of about 50 wt. %. Said hydrocarbon solvent may comprise paraffins, isoparaffins, and cycloparaffins. Said hydrocarbon solvent preferably has CAS No.: 64742-48-9 and preferably comprises less than 2% aromatics.

In a preferred embodiment, the present invention provides a cerium composition according to the first aspect of the invention, wherein said organic solvent comprises a mixture of C9-C10 alkanes and C10-C13 alkanes.

Preferably, the present invention provides a cerium composition according to the first aspect of the invention, wherein said organic solvent comprises a C6-C10 aliphatic monoalcohol ether. Preferably, said C6-C10 aliphatic monoalcohol ether is comprised in an amount of at least 30 wt. %, relative to the total weight of said organic solvent, more preferably in an amount of at least 40 wt. %, and most preferably in an amount of about 50 wt. %. Preferably, said organic solvent comprises a C1-C6 alkyl ether of diethylene glycol or dipropylene glycol, and more preferably a C1-C4 alkyl ether of diethylene glycol or dipropylene glycol.

Preferably, the present invention provides a cerium composition according to the first aspect of the invention, wherein said organic solvent is a mixture of a hydrocarbon solvent comprising C10-C13 alkanes and a C6-C10 aliphatic monoalcohol ether, whereby said hydrocarbon solvent is comprised in an amount of 30 wt. % to 70 wt. %, relative to the total weight of said organic solvent, and whereby said aliphatic monoalcohol ether is comprised in an amount of 70 wt. % to 30 wt. %, relative to the total weight of said organic solvent, respectively. More preferably, said hydrocarbon solvent is comprised in an amount of 40 wt. % to 60 wt. %, and said aliphatic monoalcohol ether is comprised in an amount of 60 wt. % to 40 wt. %, respectively. Most preferably, said hydrocarbon solvent is comprised in an amount of about 50 wt. %, and said aliphatic monoalcohol ether is comprised in an amount of about 50 wt. %.

Preferably, the present invention provides a cerium composition according to the first aspect of the invention, wherein said organic solvent comprises one or more saturated and/or unsaturated C5-C11 esters. Preferred esters may be ethyl lactate.

Preferably, the present invention provides a cerium composition according to the first aspect of the invention, wherein said organic solvent comprises one or more saturated and/or unsaturated C12-C30 esters, more preferably of bio-based and/or bio-sourced saturated and unsaturated C12-C30 esters. Preferably, said unsaturated C12-C30 ester is comprised in an amount of at least 80 wt. %, relative to the total weight of the organic solvent, more preferably in an amount of at least 90 wt. %, and even more preferably in an amount of at least 98 wt. %. In a first preferred embodiment, said unsaturated C12-C30 ester is a methyl ester of rapeseed, or an ester derived from fatty acids such as soy 2-ethylhexyl ester, and the like. Methyl ester of rapeseed (RME) is a methyl ester mixture made up of saturated and unsaturated C16 to C22 fatty acids. Technically, methyl esters of rapeseed are produced by chemical conversion of rapeseed oil using methanol. In a second preferred embodiment, said unsaturated C12-C30 ester is soy 2-ethylhexyl ester, also referred to as soybean 2-ethylhexyl ester. Said unsaturated C12-C30 ester may be comprised as a mixture of two or more ester products.

Preferably, the present invention provides a cerium composition according to the first aspect of the invention, wherein said organic solvent comprises a C1-C6 N-alkyl pyrrolidone, more preferably a C4 N-alkyl pyrrolidone. Preferably, said C1-C6 N-alkyl pyrrolidone is comprised in an amount of at least 80 wt. %, relative to the total weight of the organic solvent, more preferably in an amount of at least 90 wt. %, and even more preferably in an amount of at least 98 wt. %. Preferably, said C1-C6 N-alkyl pyrrolidone is a C4 N-alkyl pyrrolidone.

In a second aspect of the general inventive concept of the present invention, the present invention provides a process for preparing a cerium composition, comprising the steps of:
step a) contacting a long-chain carboxylic acid with a Ce (III) compound preferably in presence of a short-chain carboxylic acid, and/or a hydrate and/or anhydride thereof, under a non-oxidative atmosphere, whereby said Ce (III) compound is selected from the group comprising Ce (III) carbonate, Ce (III) hydroxycarbonate, Ce (III) hydroxide, Ce (III) oxyhydroxide, and/or Ce (III) oxide, and whereby said long-chain carboxylic acid is provided in a stoichiometric excess relative to the amount of Ce (III) compound, thereby obtaining a mixture of a long-chain Ce (III) carboxylate and a short-chain Ce (III) carboxylate in a long-chain carboxylic acid; and
step b) adding an organic solvent to the mixture obtained in step a).

Said Ce (III) compound provided in step a) may be provided as such, and/or may comprise a hydrate thereof. Preferably, said long-chain carboxylate and said long-chain carboxylic acid are carboxylic acids having 6 to 24 carbon atoms, preferably 9 to 20 carbon atoms, and more preferably 10 to 16 carbon atoms. In some embodiments, said long-chain carboxylic acid may be comprised as a mixture of two or more long-chain carboxylic acids. In some embodiments, said carboxylic acid is selected of the group comprising saturated carboxylic acids such as alkyl and cycloalkyl acids, and unsaturated carboxylic acids. Said carboxylic acid may include aliphatic, alicyclic, aryl and alkylaryl groups. Preferably, said long-chain carboxylic acid is comprised of a unsaturated carboxylic acid. Selected long-chain carboxylic acids are: naphthenic acid, octanoic acid, 2-ethylhexanoic acid, isononaic acid, 3,5,5-trimethylhexanoic acid, versatic acid, oleic acid, ricinoleic acid, stearic acid and neodecanoic acid. Preferably, short-chain carboxylic acid comprises 1 to 5 carbon atoms, more preferably 2 to 4 carbon atoms. Preferably, said short-chain carboxylic acid is a saturated carboxylic acid. In some embodiments, said short-chain carboxylic acid is comprised as a hydrate or an anhydride of a short-chain carboxylic acid. Selected short-chain carboxylic acids are: formic acid, acetic acid, propionic acid, butyric acid and acetic acid anhydride. In some embodiments, said short-chain carboxylic acid may be comprised as a mixture of two or more short-chain carboxylic acids. Said organic solvent may be a blend of two or more organic solvents.

The inventors found that when the preparation of a long-chain Ce (III) carboxylate was attempted in absence of a short-chain carboxylic acid, full conversion of the starting product Ce (III) could not be achieved, and no clear solution was obtained. Hence, the presence of a short-chain carboxylic acid improves the reaction and purification of the reaction product.

In a preferred embodiment, the present invention provides process for preparing a cerium composition according to the general inventive aspect of the invention, wherein said long-chain carboxylic acid is neodecanoic acid; wherein said short-chain carboxylic acid is a carboxylic acid having a general formula RCOOH, wherein R is H or a C1 to C4 alkyl; wherein said long-chain Ce (III) carboxylate is Ce (III) neodecanoate; and wherein said short-chain Ce (III) carboxylate has a general formula RCOO⁻, wherein R is H or a C1 to C4 alkyl.

In a second aspect, the present invention provides a process for preparing a cerium composition, comprising the steps of:
step a) contacting neodecanoic acid with a Ce (III) compound preferably in presence of an organic acid having a general formula RCOOH, wherein R is H or a C1 to C4 alkyl, and/or a hydrate and/or anhydride thereof, under a non-oxidative atmosphere, whereby said Ce (III) compound is selected from the group comprising Ce (III) carbonate, Ce (III) hydroxycarbonate, Ce (III) hydroxide, Ce (III) oxyhydroxide, and/or Ce (III) oxide, and whereby neodecanoic acid is provided in a stoichiometric excess relative to the amount of Ce (III) compound, thereby obtaining a mixture of Ce (III) neodecanoate and Ce (III) carboxylate in neodecanoic acid; and
step b) adding an organic solvent to the mixture obtained in step a).

The inventors have found that the conversion of the Ce (III) compound to Ce (III) neodecanoate progresses more easily when a stoichiometric excess of neodecanoic acid is used, and that the excess of neodecanoic acid does not hinder the effectivity of the fuel borne catalyst composition for use in catalytic soot reduction, while no significant negative side effects were observed. The inventors also discovered that the use of a carboxylic acid having 1 to 5 carbon atoms facilitates the conversion of the Ce (III) compound. It is presumed that short chain carboxylic acids improve the solubility of the Ce (III) compound in the reaction mixture. The inventors also found that the organic solvent is preferably added after the long-chain carboxylic acid is contacted with the Ce (III) compound in presence of the short-chain carboxylic acid.

In a preferred embodiment, excess amounts of neodecanoic acid, or excess amounts of long-chain carboxylic acid, may be neutralized or partially neutralized using a re-active base such as NaOH or KOH.

In a preferred embodiment, said Ce (III) compound is selected from the group comprising Ce (III) carbonate, Ce (III) hydroxycarbonate, Ce (III) hydroxide, Ce (III) oxyhydroxide, and/or Ce (III) oxide, and more preferably from the group comprising Ce (III) carbonate, Ce (III) hydroxycarbonate, and/or hydrates thereof.

In a preferred embodiment, said organic acid is selected from the group comprising formic acid, acetic acid, propionic acid and butyric acid, more preferably said organic acid is formic acid, acetic acid, propionic acid, and most preferably said organic acid is acetic acid. A combination of two or more organic acids may advantageously be used.

In a preferred embodiment, the present invention provides a process according to the second aspect of the invention, whereby said neodecanoic acid is contacted with said Ce (III) compound in presence of said organic acid at a temperature between 60° C. and 180°C. More preferably, said neodecanoic acid is contacted with said Ce (III) compound in presence of said organic acid at a temperature between 80° C. and 120° C., and more preferably at a temperature between 90° C. and 100° C. Preferably, said neodecanoic acid is contacted with said Ce (III) compound under rigorous stirring.

In a preferred embodiment, the present invention provides a process according to the second aspect of the invention, whereby said organic solvent is added to the mixture obtained in step a) at a temperature between 100° C. and 200° C. More preferably, said organic solvent is added to the mixture obtained in step a) at a temperature between 120° C. and 160° C., and more preferably at a temperature between 130° C. and 150° C. Preferably, said organic solvent is added under rigorous stirring.

In a preferred embodiment, the present invention provides a process according to the second aspect of the invention, whereby the mixture obtained in step a) is filtered, and whereby additionally an organic solvent is added to the filtrate. Said solvent is added to obtain a predetermined concentration of Ce.

In a preferred embodiment, the present invention provides a process according to the second aspect of the invention for preparing a cerium composition according to the first aspect of the invention.

In a third aspect, the present invention provides a method for reducing emissions of particulates from diesel engines, whereby a diesel engine is fed with a fuel composition comprising a fuel, Ce (III) neodecanoate and a Ce (III) carboxylate, wherein said carboxylate has a general formula RCOO-, wherein R is H or a C1 to C4 alkyl.

More specifically, the method according to the third aspect of the invention relates to a method for reducing emissions of particulates from diesel engines, said method comprising the steps of: operating a diesel engine with a fuel containing a fuel borne catalyst comprising a fuel-soluble or fuel-dispersible cerium composition; passing exhaust produced by combustion of the fuel and containing cerium oxide released from the fuel by combustion, through a diesel particulate filter to collect particulate matter in said diesel particulate filter; and regenerating said diesel particulate filter by increasing the temperature to a temperature between 300° C. and 700° C., more preferably to a temperature between 350° C. and 650°C., even more preferable between 400° C. and 600° C. and most preferably to a temperature of about 400° C., 425° C., 450° C., 475° C., 500° C., 525° C., 550° C. or 575° C., or any temperature there in between. Most preferably, said diesel particulate filter is regenerated at a temperature between 400° C. and 500° C. Preferably, said cerium composition further comprises neodecanoic acid. Preferably, said cerium composition further comprises an organic solvent. More preferably, said cerium composition is a fuel borne catalyst composition according to the first aspect of the invention. In a preferred embodiment, the present invention provides a method according to the third aspect of the invention, whereby said fuel composition further comprises neodecanoic acid.

In a fourth aspect, the present invention provides a use of a cerium composition according to the first aspect of the invention as a soot reduction catalyst composition.

In a specifically preferred embodiment, the present invention provides:

A cerium composition for use as a soot reduction catalyst system, comprising:
i. Ce (III) neodecanoate;
ii. Ce (III) carboxylate, wherein said carboxylate has a general formula RCOO⁻, wherein R is H or a C1 to C4 alkyl;
iii. neodecanoic acid; and
iv. an organic solvent.

More specifically, the aforementioned cerium composition, comprising:
i. Ce (III) neodecanoate, in an amount of 20 to 55 wt. %, relative to the total weight of the composition;
ii. Ce (III) carboxylate, wherein said carboxylate has a general formula RCOO⁻, wherein R is H or a C1 to C4 alkyl, in an amount of 0.1 to 10 wt. %, relative to the total weight of said composition;
iii. neodecanoic acid, in an amount of 1 to 30 wt. %, relative to the total weight of said composition; and
iv. an organic solvent, in an amount of 5 to 78.9 wt. %, relative to the total weight of said composition.

More specifically, the aforementioned cerium composition, comprising:
i. Ce (III) neodecanoate, in an amount of 40 to 45 wt. %, relative to the total weight of the composition;
ii. Ce (III) carboxylate, wherein said carboxylate has a general formula RCOO⁻, wherein R is H or a C1 to C4 alkyl, in an amount of 1 to 3 wt. %, relative to the total weight of said composition;
iii. neodecanoic acid, in an amount of 2 to 30 wt. %, relative to the total weight of said composition; and
iv. an organic solvent, in an amount of 22 to 57 wt. %, relative to the total weight of said composition.

More specifically, the aforementioned cerium composition, wherein the molar ratio of neodecanoic acid to Ce (III) neodecanoate is between 0.1 and 5.0.

More specifically, the aforementioned cerium composition, wherein said carboxylate is selected from the group comprising: formate, acetate and propionate.

More specifically, the aforementioned cerium composition, wherein said organic solvent is a hydrocarbon solvent comprising C10-C13 alkanes.

More specifically, the aforementioned cerium composition, wherein said organic solvent is a C6-C10 aliphatic monoalcohol ether.

More specifically, the aforementioned cerium composition, wherein said organic solvent comprises one or more bio-based and/or bio-sourced, saturated and/or unsaturated C12-C30 esters.

A process for preparing a cerium composition, comprising the steps of:
i. contacting neodecanoic acid with a Ce (III) compound in presence of an organic acid having a general formula RCOOH, wherein R is H or a C1 to C4 alkyl, and/or a hydrate and/or anhydride thereof, under a non-oxidative atmosphere, whereby said Ce (III) compound is selected from the group comprising Ce (III) carbonate, Ce (III) hydroxycarbonate, Ce (III) hydroxide, Ce (III) oxyhydroxide, and/or Ce (III) oxide, and/or hydrates thereof, and whereby neodecanoic acid is provided in a stoichiometric excess relative to the amount of Ce (III) compound, thereby obtaining a mixture of Ce (III) neodecanoate and Ce (III) carboxylate in neodecanoic acid; and
ii. adding an organic solvent to the mixture obtained in step a).

More specifically, the aforementioned process, whereby said neodecanoic acid is contacted with said Ce (III) compound in presence of said organic acid at a temperature between 60° C. and 180° C.

More specifically, the aforementioned process, whereby said organic solvent is added to the mixture obtained in step a) at a temperature between 100° C. and 200° C.

More specifically, the aforementioned process, whereby the mixture obtained in step a) is filtered, and whereby said organic solvent is added to the filtrate.

A method for reducing emissions of particulates from diesel engines, said method comprising the steps of: operating a diesel engine with a fuel composition comprising a fuel, Ce (III) neodecanoate and a Ce (III) carboxylate, wherein said carboxylate has a general formula RCOO⁻, wherein R is H or a C1 to C4 alkyl, neodecanoic acid and an organic solvent; passing an exhaust produced by combustion of the fuel and containing cerium oxide released from the fuel by combustion through a diesel particulate filter to collect particulate matter in said diesel particulate filter; and regenerating said diesel particulate filter by increasing the temperature to a temperature between 350° C. and 600°C.

More specifically, the aforementioned method, whereby said diesel particulate filter is regenerating by increasing the temperature to a temperature between 350° C. and 500° C.

### EXAMPLES

The following examples are intended to further clarify the present invention, and are nowhere intended to limit the scope of the present invention.

### Example 1

A reactor is flushed with nitrogen gas to provide an inert atmosphere. 804 g neodecanoic acid and 8.8 g acetic acid (80% solution in water) are admitted into the reactor and the reactor content is stirred and heated to 95° C. Over a period of 2.5 hours, 400 g cerium (III) carbonate is gradually added to the reactor while the temperature is maintained at 95° C. Finally, 8.8 g acetic acid (80% solution in water) is added and the reaction mixture is heated for 2 hours at 95° C. and subsequently for 4 hours at 140° C. Water is removed by vacuum distillation. More than 96% of cerium (III) carbonate is converted. Next, 348 mL D60 is gradually added to the reactor at a temperature of 140° C. over a period of 6 hours under an inert atmosphere of nitrogen. D60 is an organic solvent comprising predominantly of C10-C12 paraffins and naphthenes, with a very low aromatic content. Traces of water may further be removed by vacuum distillation. After cooling to about 100° C., the reaction mixture is filtered off, and D60 is further added to the filtrate until a Ce content of about 10 wt. % is achieved. The obtained composition has a density of 1.0 g/mL.

### Example 2

The procedure according to Example 1 is repeated whereby cerium (III) hydroxide is used as a cerium salt instead of cerium (III) carbonate.

### Example 3

The procedure according to Example 1 is repeated whereby formic acid is used instead of acetic acid.

### Example 4

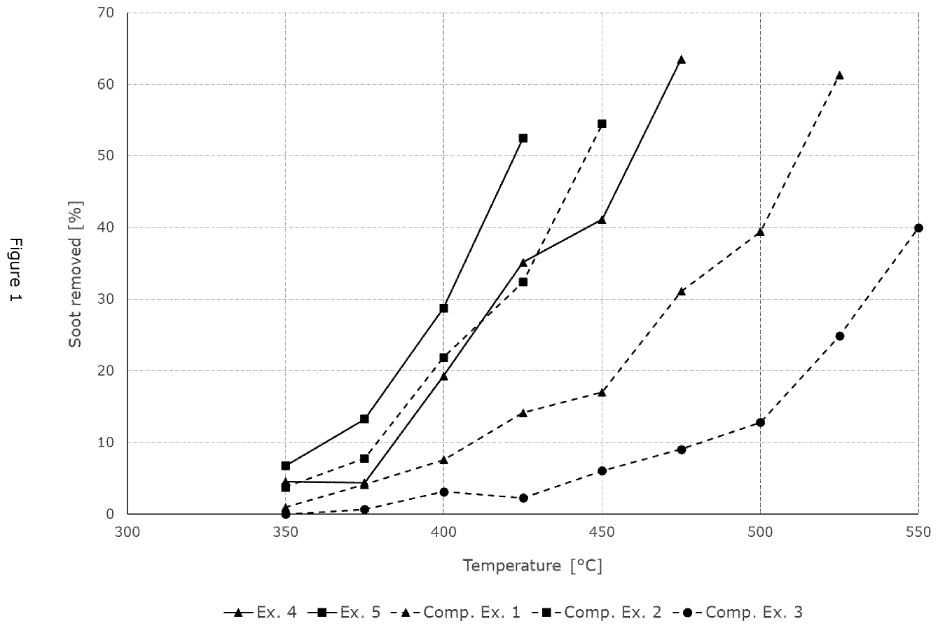

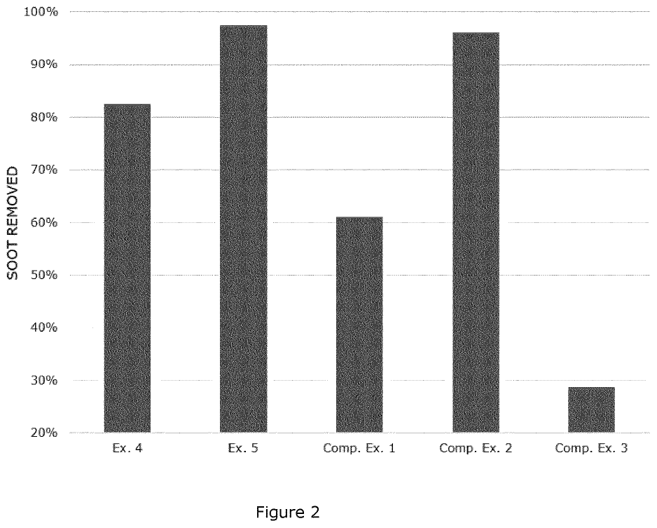

A cerium composition obtained by the process according to Example 1 is dosed in fuel at 0.2 g/L to generate 24 ppm Ce. Soot removal test are shown in FIGS. 1 and 2.

### Example 5

A cerium composition obtained by the process according to Example 1 is dosed in fuel at 1.0 g/L to generate 120 ppm Ce. Soot removal test are shown in FIGS. 1 and 2.

### Example 6

A reactor is flushed with nitrogen gas to provide an inert atmosphere. 803.4 g neodecanoic acid and 8.6 g propionic acid are admitted into the reactor and the reactor content is stirred and heated to 95° C. Over a period of 1.5 hours, 400 g cerium (III) carbonate is gradually added to the reactor while the temperature is maintained at 95° C. Finally, 8.6 g propionic acid is added, and the reaction mixture is heated for 2 hours at 95° C. and subsequently for 6 hours at 140° C. while distilling water. Traces of water may further be removed by vacuum distillation. Next, 347 mL D60 is gradually added to the reactor at a temperature of 140° C. over a period of 3 hours under an inert atmosphere of nitrogen. The reaction mixture is kept at 140° C. for an additional 6 hours while distilling water. Traces of water may further be removed by vacuum distillation. After cooling to about 100° C., the reaction mixture is filtered off, and D60 is further added to the filtrate until a Ce content of about 10 wt. % is achieved. The obtained composition has a density of 1.0 g/mL. +99% of the added cerium (III) carbonate is converted.

### Example 7

A reactor is flushed with nitrogen gas to provide an inert atmosphere. 803.5 g neodecanoic acid is admitted into the reactor and the reactor content is stirred and heated to 95° C. Over a period of 2.5 hours, 400 g cerium (III) carbonate is gradually added to the reactor while the temperature is maintained at 95° C. The reaction mixture is heated for 2 hours at 95° C. and subsequently for 4 hours at 140° C., while distilling water. Traces of water may further be removed by vacuum distillation. Next, 346 mL D60 is gradually added to the reactor at a temperature of 140° C. over a period of 2 hours under an inert atmosphere of nitrogen The reaction mixture is kept at 140° C. for an additional 6 hours while distilling water. Traces of water may further be removed by vacuum distillation. After cooling to about 100° C., the reaction mixture is filtered off. The obtained filtrate has a Ce content of about 9.7 wt. % and a density of +/−1.0 g/mL. 81% of the added cerium (III) carbonate is converted.

### Example 8

A reactor is flushed with nitrogen gas to provide an inert atmosphere. 672.7 g 2-ethylhexanoic acid and 8.8 g acetic acid (80% solution in water) are admitted into the reactor and the reactor content is stirred and heated to 95° C. Over a period of 2.5 hours, 400 g cerium (III) carbonate is gradually added to the reactor while the temperature is maintained at 95° C. Finally, 8.8 g acetic acid (80% solution in water) is added, and the reaction mixture is heated for 2 hours at 95° C. and subsequently for 4 hours at 140° C. Water is removed by vacuum distillation. Next, 430 mL D60 is gradually added to the reactor at a temperature of 140° C. over a period of 2 hours under an inert atmosphere of nitrogen The reaction mixture is kept at 140° C. for an additional 6 hours while distilling water. Traces of water may further be removed by vacuum distillation. After cooling to about 100° C., 316 mL D60 is further added. The obtained composition has a density of 0.97 g/mL and a cerium content of 10.6 wt. %. More than 99% of cerium (III) carbonate is converted.

### Example 9

A reactor is flushed with nitrogen gas to provide an inert atmosphere. 672.7 g 2-ethylhexanoic acid is admitted into the reactor and the reactor content is stirred and heated to 95° C. Over a period of 2.5 hours, 400 g cerium (III) carbonate is gradually added to the reactor while the temperature is maintained at 95° C. The reaction mixture is heated for 2 hours at 95° C. and subsequently for 4 hours at 140° C. Water is removed by vacuum distillation. Next, 430 mL D60 is gradually added to the reactor at a temperature of 140° C. over a period of 2 hours under an inert atmosphere of nitrogen The reaction mixture is kept at 140° C. for an additional 6 hours while distilling water. Traces of water may further be removed by vacuum distillation. An additional 290 mL D60 is added and the reaction mixture is filtered. The obtained composition has a density of 0.97 g/mL. Less than 92 wt. % of cerium (III) carbonate is converted

### Example 10

A reactor is flushed with nitrogen gas to provide an inert atmosphere. 758 g Versatic™ acid 913 and 8.8 g acetic acid (80% solution in water) are admitted into the reactor and the reactor content is stirred and heated to 95° C. Versatic™ Acid 913 is a mixture of tertiary carboxylic acids from C6 to C13, with C9 being the main component. Over a period of 2 hours, 400 g cerium (III) carbonate is gradually added to the reactor while the temperature is maintained at 95° C. Finally, 8.8 g acetic acid (80% solution in water) is added, and the reaction mixture is heated for 2 hours at 95° C. and subsequently for 7 hours at 140° C. Water is removed by vacuum distillation. Next, 348 mL D60 is gradually added to the reactor at a temperature of 140° C. over a period of 1.5 hours under an inert atmosphere of nitrogen. After an additional 9 hours at 140° C., the reaction mixture was cooled to about 100° C. and the reaction mixture is filtered off. A filtrate with a Ce content of about 9.7 wt. % is achieved. More than 79% of cerium (III) carbonate is converted.

### Example 11

A reactor is flushed with nitrogen gas to provide an inert atmosphere. 336.3 g caprylic acid, 401.7 g capric acid and 8.8 g acetic acid (80% solution in water). Over a period of 1.5 hours, 400 g cerium (III) carbonate is gradually added to the reactor while the temperature is maintained at 95° C. Finally, 8.8 g acetic acid (80% solution in water) is added, and the reaction mixture is heated for 2 hours at 95° C. and subsequently for 6.5 hours at 140° C. while distilling water. Residual water is removed by vacuum distillation. Next, 348 mL D60 is gradually added to the reactor at a temperature of 140° C. over a period of 2 hours under an inert atmosphere of nitrogen. After an additional 6.5 hours at 140° C., 400 mL D60 is added and the reaction mixture is filtered off. A filtrate with a Ce content of about 9.6 wt. % is achieved, which solidified on cooling. More than 99% of cerium (III) carbonate is converted.

### Example 12

A reactor is flushed with nitrogen gas to provide an inert atmosphere. 737.2 g isononanoic acid and 8.8 g acetic acid (80% solution in water). Over a period of 2 hours, 400 g cerium (III) carbonate is gradually added to the reactor while the temperature is maintained at 95° C. Finally, 8.8 g acetic acid (80% solution in water) is added, and the reaction mixture is heated for 2 hours at 95° C. and subsequently for 7 hours at 140° C. Water is removed by vacuum distillation. Next, 430 mL D60 is gradually added to the reactor at a temperature of 140° C. over a period of 1.5 hours under an inert atmosphere of nitrogen. After an additional 6 hours at 140° C., the reaction mixture was cooled to about 100° C., 277 mL D60 is further added and the reaction mixture is filtered off. A filtrate, which solidified on standing at room temperature, was obtained with a Ce content of 9.77 wt. %. More than 97% of cerium (III) carbonate is converted. D60 is further added to the filtrate until a Ce content of about 9.5 wt. % is achieved, a metal concentration at which the filtrate remains liquid at room temperature.

### Comparative Example 1

A cerium dioxide nanoparticle material (8-10 nm) is dosed in fuel at 0.35 g/L to generate 24 ppm Ce. Soot removal test are shown in FIGS. 1 and 2.

### Comparative Example 2

A cerium dioxide nanoparticle material (8-10 nm) is dosed in fuel at 1.5 g/L to generate 120 ppm Ce. Soot removal test are shown in FIGS. 1 and 2.

### Comparative Example 3

No soot removal catalyst system is dosed. Soot removal test are shown in FIGS. 1 and 2.

FIG. 1 shows the efficiency of soot removal, expressed as a percentage of the total amount of soot, as a function of the oxidative temperature. The results show that the soot reduction additive according to the invention allows for higher soot conversion at any temperature tested. FIG. 1 shows that the soot removal efficacity is significantly improved at any temperature when a Ce-based soot removal catalyst is used. Higher loadings of soot removal catalyst composition allow for higher soot removal. Importantly, the cerium compositions according to the present invention show significantly improved soot removal activity, and allow for high soot removal efficacy, even at lower temperatures such as 450° C. to 475° C., or even as low as 400° C. to 425° C.

FIG. 2 shows the efficiency of soot removal after 10 minutes at 575° C. for cerium compositions according to the invention, cerium compositions according to the prior art, and compositions without soot removal catalyst, respectively. The results show that the soot reduction additive according to the invention ensures the formation of lower amounts of ashes, compared to cerium dioxide nanoparticles. FIG. 2 shows that a high soot removal efficiency is achieved, even at lower catalyst loadings, for cerium compositions according to the present invention. All soot removal catalyst compositions perform better than soot removal without soot removal catalyst. Further experiments under the same conditions showed that for Example 4, a regeneration time of less than 7 minutes was achieved; for Example 5, a regeneration time of less than 4 minutes was achieved. Hence, the inventive compositions allow for higher soot conversion and improved regeneration kinetics.

Further experiments showed that during the soot removal operation about 0.8 g ash is generated per g cerium for the cerium composition according to Example 4, whereas about 1.4 g ash per g metal is generated for the composition according to Comparative Example 1; and that about 0.8 g ash is generated per g metal for the cerium composition according to Example 5, whereas about 1.1 g ash per g metal is generated for the composition according to Comparative Example 2.

1-22. (canceled)

23. A cerium composition for use as a soot reduction catalyst comprising a Ce (III) long-chain carboxylate in an organic solvent, wherein said long-chain carboxylate has a general formula R_{L}COO⁻, wherein R_{L} is a C6 to C24 alkyl.

24. The cerium composition according to claim 23, comprising a content of Ce (III) of 1 to 20 wt. %, relative to the total weight of the composition.

25. The cerium composition according to claim 23, comprising:
i. Ce (III) long-chain carboxylate, wherein said long-chain carboxylate has a general formula R_{L}COO⁻, wherein R_{L} is a C6 to C24 alkyl;
ii. optionally, Ce (III) carboxylate, wherein said carboxylate has a general formula RCOO⁻, wherein R is H or a C1 to C4 alkyl;
iii. a long-chain carboxylic acid, wherein said long-chain carboxylic acid is a conjugated acid of said long-chain carboxylate; and
iv. an organic solvent.

26. The cerium composition according to claim 25, comprising:
i. Ce (III) long-chain carboxylate, in an amount of 20 to 55 wt. %, relative to the total weight of the composition;
ii. Ce (III) carboxylate, in an amount of 0.1 to 10 wt. %, relative to the total weight of said composition;
iii. long-chain carboxylic acid, in an amount of 1 to 30 wt. %, relative to the total weight of said composition; and
iv. an organic solvent, in an amount of 5 to 78.9 wt. %, relative to the total weight of said composition.

27. The cerium composition according to claim 26, comprising:
i. Ce (III) long-chain carboxylate, in an amount of 40 to 45 wt. %, relative to the total weight of the composition;
ii. Ce (III) carboxylate, in an amount of 1 to 3 wt. %, relative to the total weight of said composition;
iii. long-chain carboxylic acid, in an amount of 2 to 30 wt. %, relative to the total weight of said composition; and
iv. an organic solvent, in an amount of 22 to 57 wt. %, relative to the total weight of said composition.

28. The cerium composition according to claim 25, wherein said long-chain carboxylate and said long-chain carboxylic acid consist of a mixture of two or more long-chain carboxylate and long-chain carboxylic acids, respectively.

29. The cerium composition according to claim 25, wherein the molar ratio of long-chain carboxylic acid to Ce (III) long-chain carboxylate is between 0.1 and 5.0.

30. The cerium composition according to claim 25, wherein said carboxylate RCOO⁻ is selected from the group consisting of formate, acetate, and propionate.

31. The cerium composition according to claim 23, wherein said organic solvent is a hydrocarbon solvent comprising C10-C13 alkanes.

32. The cerium composition according to claim 23, wherein said organic solvent is a C6-C10 aliphatic monoalcohol ether.

33. The cerium composition according to claim 23, wherein said organic solvent comprises one or more bio-based and/or bio-sourced, saturated and/or unsaturated C12-C30 esters.

34. A process for preparing a cerium composition, comprising the steps of:
step a) contacting a long-chain carboxylic acid having a general formula R_{L}COO⁻, wherein R_{L} is a C6 to C24 alkyl, with a Ce (III) compound under a non-oxidative atmosphere, wherein said Ce (III) compound comprises Ce (III) carbonate, Ce (III) hydroxycarbonate, Ce (III) hydroxide, Ce (III) oxyhydroxide, and/or Ce (III) oxide, and/or hydrates thereof, thereby obtaining a Ce (III) long-chain carboxylate; and
step b) adding an organic solvent to the product obtained in step a).

35. The process according to claim 34, whereby said long-chain carboxylic acid is contacted with a Ce (III) compound under a non-oxidative atmosphere in the presence of an organic acid having a general formula RCOOH, wherein R comprises H or a C1 to C4 alkyl, and/or a hydrate and/or anhydride thereof.

36. The process according to claim 34, wherein said long-chain carboxylic acid is provided in a stoichiometric excess relative to the amount of said Ce (III) compound.

37. The process according to claim 34, wherein said long-chain carboxylic acid is contacted with said Ce (III) compound at a temperature between 60° C. and 180° C.

38. The process, according to claim 34, wherein said long-chain carboxylic acid is contacted with said Ce (III) compound in the presence of said organic acid.

39. The process according to claim 34, wherein said organic solvent is added to the product obtained in step a) at a temperature between 100° C. and 200° C.

40. The process according to claim 34, wherein the product obtained in step a) is filtered, and said organic solvent is added to the filtrate.

41. A method for reducing emissions of particulates from diesel engines, said method comprising the steps of:
operating a diesel engine with a fuel composition comprising a fuel, a Ce (III) long-chain carboxylate wherein said long-chain carboxylate has a general formula R_{L}COO⁻, wherein R_{L} is a C6 to C24 alkyl in an organic solvent;
passing an exhaust produced by combustion of the fuel and containing cerium oxide released from the fuel by combustion through a diesel particulate filter to collect particulate matter in said diesel particulate filter; and
regenerating said diesel particulate filter by increasing the temperature to a temperature between 350° C. and 600° C.

42. The method according to claim 41, whereby said method comprises the step of operating a diesel engine with a fuel composition comprising a fuel, a Ce (III) long-chain carboxylate wherein said long-chain carboxylate has a general formula R_{L}COO⁻, wherein R_{L} is a C6 to C24 alkyl, optionally a long-chain carboxylic acid having a general formula R_{L}COOH, optionally a Ce (III) carboxylate, wherein said carboxylate has a general formula RCOO⁻, wherein R is H or a C1 to C4 alkyl, and an organic solvent.

43. The method according to claim 41, wherein said diesel particulate filter is regenerated by increasing the temperature to a temperature between 350° C. and 500° C.

44. A soot reduction catalyst composition comprising a cerium composition according to claim 23.
